(19) United States
(12) Patent Application Publication
(10) Pub. No.: US 2024/0116460 A1
(43) Pub. Date: Apr. 11, 2024

(54) FASTENING CLAMP, FASTENING SYSTEM, AND ROOF ASSEMBLY

(71) Applicants: Volkswagen Aktiengesellschaft, Wolfsburg (DE); A. RAYMOND & Cie, Grenoble (FR)

(72) Inventors: Michaela GROBE, Osloss (DE); Felix WAHLANDT, Berlin (DE); Michael DE JONG, Efringen-Kirchen (DE)

(73) Assignees: Volkswagen Aktiengesellschaft, Wolfsburg (DE); A. RAYMOND & Cie, Grenoble (FR)

(21) Appl. No.: 18/377,583

(22) Filed: Oct. 6, 2023

(30) Foreign Application Priority Data
Oct. 7, 2022 (DE) 10 2022 126 005.4

(51) Int. Cl. B60R 13/02

(52) U.S. Cl. CPC B60R 13/0206; B60R 13/0212

(57) ABSTRACT

A fastening clamp for fastening a molded headliner to a vehicle roof, in particular a panoramic or sliding roof, having a base element which is formed plate-shaped. Two support elements are arranged opposite one another and extend away from the base element and at least substantially towards one another. A latching element projects from the support element and is arranged on each support element for latching the fastening clamp to the molded headliner or to the vehicle roof. The respective latching element has, spaced from the base element, a latching lug for engaging behind an edge section of the molded headliner or of the vehicle roof, and the respective latching lug projects from the outer side of the support element, which side faces away from the opposite support element.

This nonprovisional application claims priority under 35 U.S.C. § 119(a) to German Patent Application No. 10 2022 126 005.4, which was filed in Germany on Oct. 7, 2022, and which is herein incorporated by reference.

### BACKGROUND OF THE INVENTION

### Field of the Invention

The invention relates to a fastening clamp for fastening a molded headliner to a vehicle roof, in particular a panoramic or sliding roof, having a base element which is formed plate-shaped, having two support elements arranged opposite one another and extending away from the base element and at least substantially towards one another, wherein a latching element projecting from the support element is arranged on each support element for latching the fastening clamp to the molded headliner or to the vehicle roof, which latching element is held in an elastically displaceable manner at the respective support element end facing away from the base element and extends in the direction of the base element.

Furthermore, the invention relates to a fastening system for fastening a molded headliner to a vehicle roof, in particular a panoramic or sliding roof, having a bearing element which can be fastened to the molded headliner or the vehicle roof and has a receptacle for positively locking a fastening clamp, and having a fastening clamp which is held or can be held positively on the bearing element, wherein the fastening clamp is formed as described above.

In addition, the invention relates to a roof assembly for a vehicle, in particular a motor vehicle, having a vehicle roof, in particular a panoramic roof or sliding roof, which has a roof frame, in which a roof opening is formed, and a glass roof element which extends over the roof opening, and having a molded headliner which is fastened to an underside of the vehicle roof, which underside is associated with a vehicle interior, by the fastening system described above.

### Description of the Background Art

Fastening clamps and systems are already known from the prior art. Thus, for example, patent application DE 10 2008 052 965 A1 discloses a fastening clamp that cooperates with another fastening clamp to connect a molded headliner to a panoramic roof. In this case, the fastening clamp has inwardly projecting latching elements, therefore, elements located between the support elements, and between which a mating latching element of the vehicle roof or of the molded headliner can be inserted in order to be gripped behind by the latching elements.

### SUMMARY OF THE INVENTION

It is therefore an object of the invention of creating an improved fastening clamp that enables an improved clearance compensation and yet can be realized cost-effectively.

In an example, the fastening clamp of the invention has the advantage that, due to an advantageous design of the fastening clamp, it can be fastened firstly directly to the molded headliner or the vehicle roof, in particular without the interposition of a mating latching element, and that an advantageous clearance compensation is ensured in a simple manner. According to the invention, it is provided for this purpose that the respective latching element has, spaced from the base element, a latching lug for engaging behind an edge section of the molded roof or of the vehicle roof, and that the respective latching lug projects from the outer side of the support element, which side faces away from the opposite support element. The fastening clamp of the invention thus moves the fastening point of the fastening clamp on the molded headliner or vehicle roof outward, therefore, to an area outside the fastening clamp area enclosed by the base element and support elements. This allows the fastening clamp in particular to be inserted directly into an opening in the molded headliner or the vehicle roof and latched therein. Because the latching lug is located outside the support elements, a longitudinal displacement of the receptacle along the vehicle roof or the molded headliner can be realized by simple means. In addition, the latching lug ensures not only that the fastening clamp is latched to the molded headliner, but also that a height compensation can occur by the elastic displacement of at least the latching elements. The height of the fastening clamp may be understood to be the extent of the fastening clamp perpendicular to the base element, for example, along a mirror plane between the opposite support elements. Preferably, the support elements each have two support legs arranged at a distance from one another, which are connected to one another, in particular integrally, by a crosspiece on the end facing away from the base element. Particularly preferably, the respective latching element can be held on the crosspiece between the adjacent support legs of the respective support element and, in particular, is formed integrally therewith. The elastic displaceability of the latching element is thereby preferably ensured by an elastic deformation of the latching element, in particular in the transition to the support element.

The base element can have two guide rails arranged parallel to one another, each extending from one support element to the opposite support element, and projecting laterally from the support elements for accommodation in a rail guide, for example, as side edges. The advantageous refinement of the fastening clamp achieves that the base element itself is displaceably mounted on a mating element, such as, for example, the molded headliner or the vehicle roof, or is displaceably mounted in an intermediate bearing element. This advantageously ensures a tolerance compensation between the molded headliner and the vehicle roof in a further direction. In particular, the guide rails extend transversely to the longitudinal extent of the latching receptacles, so that the fastening clamp can be displaced in a first direction in the area of the latching receptacle and in a second direction transverse to the first direction in the area of the base element.

The support elements, at least one support leg of the respective support element, and the latching elements can each be formed strip-shaped. Thus, the support elements and the latching elements can have a rectangular cross section with a small depth compared to its width. As a result, the support elements and the latching elements are themselves designed to be elastically deformable in an advantageous manner, so that the fastening clamp as a whole can be advantageously mounted, in particular without damaging the fastening clamp itself or the molded headliner or the vehicle roof during mounting. In particular, the support elements and latching elements are oriented in such a way that they are oriented parallel to each other in the width extent, so that they lie in the same bending plane or can be deformed in the same plane.

The respective latching element can have a free end spaced from the base element. The respective latching element can be held at one end thereby on the associated support element and is designed to oscillate freely at the other end, wherein the free-swinging end is associated with the base element but spaced therefrom. This ensures an advantageously large displacement path of the respective latching element. In addition, the elastic bearing, which is held at only one end, ensures that the latching element can be displaced with little force, so that the fastening clamp can also be installed without a great deal of force.

Furthermore, the respective free end can have a retaining element which extends parallel to the base section at least in the unloaded state of the fastening clamp. By means of the retaining element or by means of the end section, an advantageous orientation of the fastening clamp on the molded headliner or the vehicle roof with respect to the base element is achieved, which in particular achieves a secure and robust support of the molded headliner or the vehicle roof on the end section.

Furthermore, The support elements can be formed integrally with the base element. On the one hand, this creates a robust connection between the support element and the base element, and, on the other hand, it enables a cost-effective production. Preferably, the support elements have at least one bend in their course. The bending gives the respective support element in particular a preferred weighing direction and/or an orientation, in particular an insertion slope, which facilitates the insertion of the support elements and thus of the fastening clamp as a whole into the opening of the roof liner or the molded headliner.

The latching elements at one end can be formed integrally with the respective support element. Each of the latching elements is thus formed integrally with its associated support element. If the support elements are also formed integrally with the base element, the latching elements are formed integrally with both the support elements and the base element. This provides a particularly advantageous and cost-effective example of the fastening clamp.

Also, at the other end the latching elements can be formed integrally with the base element. Thus, the latching elements are integrally connected to the base element at the end facing the base element. In this case, therefore, the latching elements do not have a free end with a retaining element, but instead merge integrally into the base element. This increases the overall stability and robustness of the fastening clamp. In particular, because the respective latching element is formed at one end integrally with the support element and at the other end integrally with the base element, particularly high latching forces can be achieved, which ensure a permanently secure locking of the molded headliner to the vehicle roof.

The fastening clamp can be formed as a stamped-bent part, which reduces manufacturing costs and assembly effort.

The free ends of the support elements may abut and/or may be fastened to one another. This increases the robustness, in particular a rigidity of the fastening clamp in an advantageous way.

One of the free ends of the support elements, therefore, at the end facing away from the base element, can have a bending tab which engages around the free end of the other support element. This ensures a positive connection of the free ends of the support elements to each other, making the fastening clamp robust and guaranteeing a long service life. The bending tab can moreover eliminate a material bond, such as, for example, welding or soldering of the free ends together.

The fastening system of the invention may be characterized by the design of the invention for the fastening clamp. This results in the aforementioned advantages.

In particular, the fastening clamp with its guide rails can be arranged or can be arranged so as to be displaceable in a rail guide of the bearing element. Together with the base element, the bearing element thus forms a sliding guide for the fastening clamp, by means of which assembly or manufacturing tolerances of the molded headliner and/or vehicle roof can be compensated in an advantageous manner in at least one sliding direction.

Furthermore, the sliding direction of the fastening clamp on the bearing element can be oriented transversely to a sliding direction of the retaining elements or the latching receptacles on the vehicle roof or the molded headliner. Because the side edges or guide rails of the base element extend in particular transversely to the longitudinal extent of the latching receptacles, this thus results in an advantageous compensation option for the fastening system in an X-Y plane. In the Z-direction or in the height, an advantageous tolerance compensation is preferably achieved by the elastic deformability of the latching elements and in particular of the support elements as well.

The roof assembly of the invention is characterized by the design of the invention for the fastening system. In this case, this results in the aforementioned advantages. In particular, the bearing element can be fastened to the vehicle roof or to the molded headliner, for example, glued, welded, clamped, or positively held, and the fastening clamp can be fastened to the vehicle roof or the molded headliner with the latching receptacles in the manner described above. This results in the already mentioned advantageous tolerance compensation with minimal manufacturing costs and a high robustness of the overall system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an advantageous roof assembly in a simplified sectional view;

FIG. 2 shows an advantageous fastening system of the roof assembly according to an example in a perspective view;

FIG. 3 shows the roof assembly with the fastening system in an advantageous perspective view;

FIG. 4 shows the roof assembly with the fastening system in an advantageous side view;

FIG. 5 shows a fastening clamp of the fastening system according to an example in a perspective view; and

FIG. 6 shows the roof assembly with the fastening clamp according to the example in a simplified side view.

### DETAILED DESCRIPTION

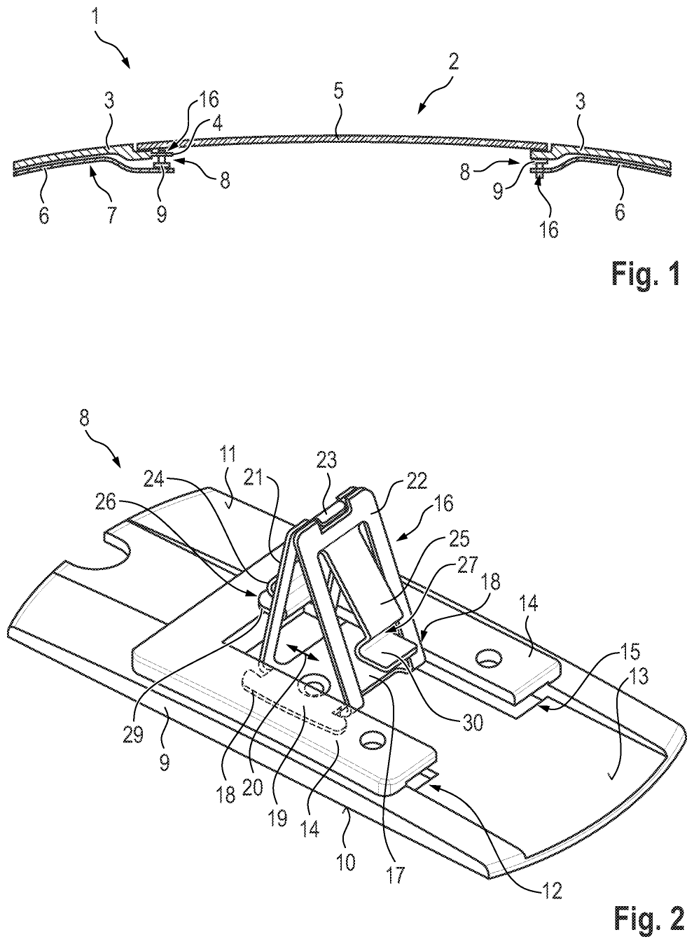

FIG. 1 shows an advantageous roof assembly 1 for a motor vehicle, in a simplified longitudinal sectional view. Roof assembly 1 has a vehicle roof 2, which has a roof frame 3 with a roof opening 4 formed thereon and in particular arranged centrally, as seen in the transverse extent. Roof opening 4 is covered or filled by a glass roof element 5 to form a panoramic glass roof. For this purpose, glass roof element 5 at its outer edge preferably rests on roof frame 3.

Furthermore, roof assembly 1 has a molded headliner 6 arranged on an underside 7 of vehicle roof 2, said underside facing the interior of the motor vehicle. In particular, molded headliner 6 is used to cover the body parts that are usually made of metal and form the roof frame, as well as to provide noise protection or sound insulation and thermal insulation for people in the interior of the motor vehicle. To this end, molded headliner 6 lies substantially flat against underside 7 of vehicle roof 2 and extends to glass roof element 5. Provided for fastening molded headliner 6 to vehicle roof 2 is a fastening system 8, which enables simple mounting in just a few steps and yet ensures a long service life and a strong connection between the molded headliner and the vehicle roof.

FIG. 2 shows a perspective view of an example of fastening system 8. This has a bearing element 9 which is formed substantially plate-shaped and can be placed with an underside 10 on the molded headliner or the vehicle roof and fastened thereto, for example, by screwing, gluing, soldering, caulking, latching, or the like. Bearing element 9 has an insertion receptacle 12 on its topside 11 facing away from underside 10. For this purpose, bearing element 9 on topside 11 has a flat bearing surface 13, which is covered in areas on opposite side edges by longitudinally extending bars 14, so that there is a distance between bars 14 and bearing surface 13. Bearing element 9 forms a rail guide 15 with bearing surface 13 and bar elements 14.

Fastening system 8 further has a fastening clamp 16 held on bearing element 9 by means of rail guide 15. For this purpose, fastening clamp 16 has a base element 17 which is plate-shaped, therefore, substantially flat. The plate-shaped base element 17 has two opposite side edges 18, which serve as guide rails 19 to be displaceably mounted in rail guide 15. Fastening clamp 16 is thus mounted longitudinally displaceable with base element 17 in insertion receptacle 12, as shown by a double arrow 20 in FIG. 2

Two support elements 21, 22 are arranged between side edges 18. Support elements 21, 22 extend starting from base section 17 and converge towards each other, so that fastening clamp 16 is triangular in shape when seen in the side view. The free ends of support elements 21, 22 facing away from base element 17 are in contact with each other. According to the example, support element 21 also has a bending tab 23 at its free end, which engages around the free end of support element 22 in areas, as a result of which support elements 21, 22 are mechanically connected to one another at their free ends.

Support elements 21, 22 are formed integrally with base element 17. Preferably, the entire fastening clamp 16 is formed in one piece and, in particular, is manufactured as a stamped-bent part.

Thus, support elements 21, 22 also have a frame-like structure or shape. Each of the support elements 21, 22 has two strip-shaped support legs, which are formed at one end on base element 17 and are connected to each other at the other end by a crosspiece, wherein, in the present example, the crosspiece of support element 21 has the previously mentioned bending tab 23 or contributes to forming it.

A latching element 24, 25 is arranged on each of the respective support elements 21, 22. According to this example, latching elements 24, 25 are designed in the form of bending tabs or latching tongues and are integrally formed at one end on the respective crosspiece of support element 21 or 22. Thus, latching elements 24, 25 lie between the support legs of support elements 21, 22 and extend in the longitudinal extent parallel to these from the respective free end of support elements 21, 22 in the direction of base element 17.

The latching elements each have a latching lug 26, 27 at their free end section facing base element 17. To form latching lug 26, 27, latching elements 24, 25 have a V- or U-shaped course at their free end, as seen in longitudinal section, so that in each case an indentation is formed in the respective latching element 24, 25, which forms latching lug 26, 27 as an element projecting from the indentation.

Latching elements 24, 25 are designed in such a way that they project outwardly or laterally from the respective support element 21, 22. In the present case, the sides of support elements 21, 22, said sides facing away from each other, are referred to as outer sides. Latching elements 24, 25 now project from these, in particular such that the indentations which adjoin latching lugs 26, 27 and which form latching receptacles, lie completely outside support elements 21, 22 or at a distance from the outer surfaces of support elements 21, 22.

The one-piece design ensures that latching elements 24, 25 can be moved towards each other with elastic deformation. If fastening clamp 16 is inserted into, for example, a rectangular opening of molded headliner 6 or vehicle roof 2, the clear width of which is narrower than the distance between the latching receptacles, latching elements 24, 25 spring in or towards each other when inserted into the opening until the edge of the opening comes to rest in the latching receptacles.

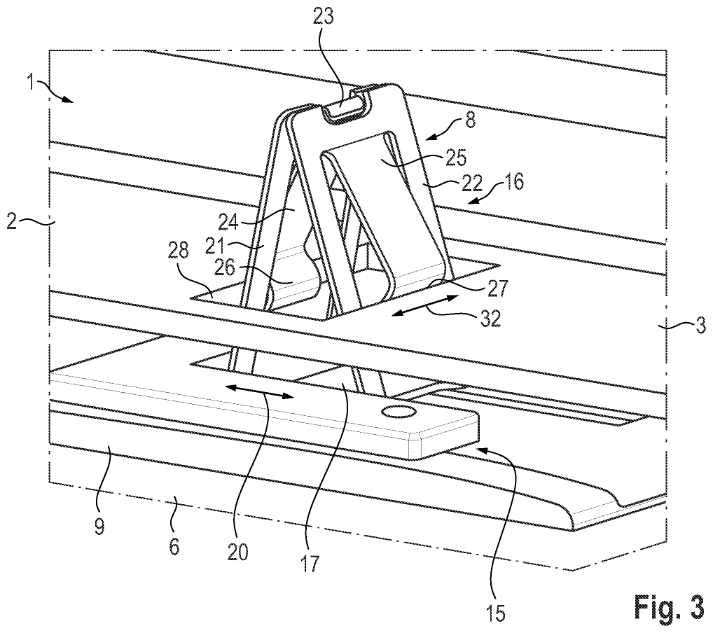

To this end, FIG. 3 shows a detailed perspective view of a mounting state of fastening system 8 on roof assembly 1. According to the present example, bearing element 9 is placed with its underside 10 on molded headliner 6 and fastened to it. Fastening clamp 16 with base element 17 is inserted into rail guide 15 and mounted longitudinally displaceable. Furthermore, fastening clamp 16 with support elements 21, 22 is inserted into a rectangular opening 28 of vehicle roof 2, in particular in the area of frame 3, wherein the clear width of opening 28 is smaller than the width of fastening clamp 16 in the area of the latching receptacles as viewed in the sliding direction of rail guide 15. The elastic deformation of latching elements 24, 25 causes vehicle roof 2 to enter the area of the latching receptacles, so that latching elements 24, 25 are again displaced outward in areas by their inherent elasticity, so that vehicle roof 2 is held positively in the latching receptacles, wherein a secure connection is permanently ensured by the pretensioning of latching elements 24, 25. In this case, the height of the latching receptacles is only slightly higher than the height of vehicle roof 2 in the fastening region, so that the edge region of opening 28 can be securely received in the respective latching receptacle, as shown in FIG. 3.

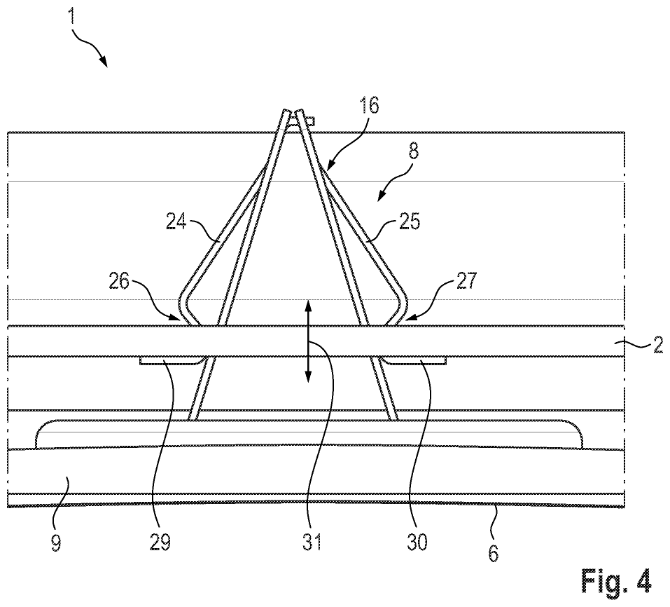

FIG. 4 shows a simplified side view of roof assembly 1 in the area of fastening system 8 or of fastening clamp 16. It can be seen here that the free ends of the latching elements form retaining elements 29, 30 which engage behind vehicle roof 2.

Due to the elastically deformable design of latching elements 24, 25, fastening clamp 16 also allows tolerance compensation in the Z- or height direction, as shown by a double arrow 31 in FIG. 4. Because opening 28 is formed wider than fastening clamp 16 or support elements 21, 22, fastening clamp 16 is mounted longitudinally displaceable in opening 28, as shown by a double arrow 32 in FIG. 3. The displacement or displaceability according to arrow 32 is transverse to the displacement according to arrow 20, which is formed by rail guide 15 and base element 17.

This has the result that the advantageous fastening clamp 16 ensures tolerance compensation both in height and in a plane perpendicular to the height. Moreover, the advantageous fastening system 8 provides easy installation.

Whereas the example shown in FIGS. 3 and 4 concerns an arrangement of fastening system 8 in such a way that bearing element 9 rests on molded headliner 6 and reaches through an opening 28 of vehicle roof 3, as shown on the left side in FIG. 1, according to a further example, as shown on the right side in FIG. 1, it is provided that the bearing element is formed on vehicle roof 3 and opening 28 is formed in molded headliner 6.

Whereas, the fastening clamp 16 can be fastened to a separate bearing element 9, a molded headliner 6, or vehicle roof 2, according to a further example it is provided that insertion receptacle 12 or rail guide 15 is arranged or formed directly in or on molded headliner 6 or on vehicle roof 2, so that fastening clamp 16 can be fastened or is fastened directly to vehicle roof 2 or molded headliner 6.

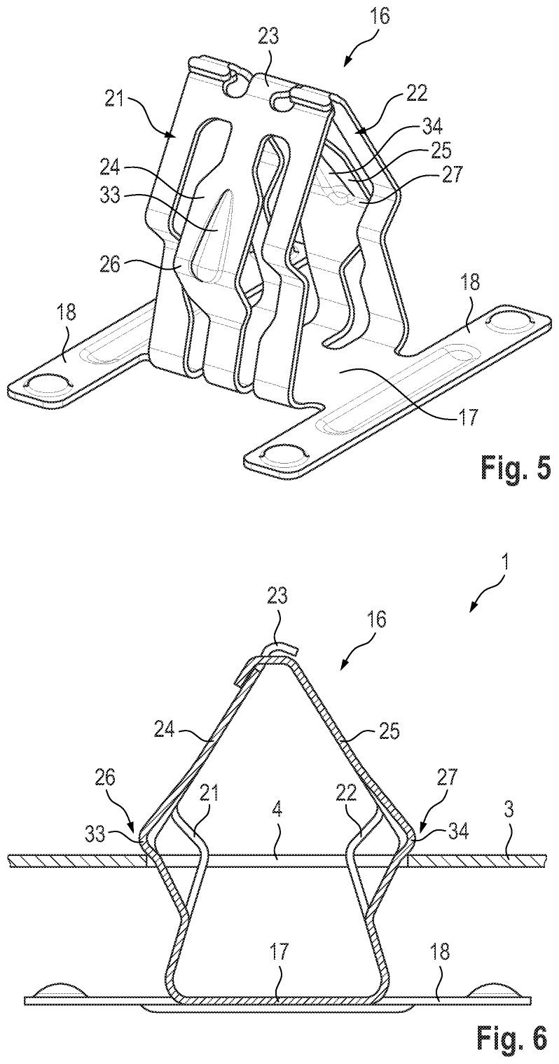

FIGS. 5 and 6 relate to a second example of fastening clamp 16. In contrast to the previous example, the respective latching element 24, 25 is integrally connected at one end to the respective support element 21, 22 as well as integrally connected at the other end to base element 17. To this end, FIG. 5 shows fastening clamp 16 in a perspective view. Thus, in contrast to the example, latching elements 24, 25 do not have a free end or free end section. Latching lugs 26, 27 are formed substantially as in the previous example by bending or deforming the respective latching element 24, 25 in its longitudinal extent. At this point, an indentation or latching receptacle is formed in the respective latching element 24, 25 between the respective latching lug 26, 27 and base element 17. This indentation then does not end in retaining element 30 extending parallel to and spaced from the base element, but integrally merges with base element 17. The respective latching element 24, 25 is thus given a zigzag longitudinal course in particular.

The shape of the support elements, seen in side view, also differs from the previous examples. In the present case, it is provided that support elements 21, 22 have an additional bend so that they are given an s-shaped course. In this case, the bending points are offset from the bending points of the associated latching elements 24, 25 with respect to the height of fastening clamp 16, so that support elements 21, 22 and latching elements 24, 25 are elastically bent at different points during mounting. Because the support elements also have an s-shape in their longitudinal course, despite the one-piece design of latching elements 24, 25, advantageous force-reduced mounting is possible at both ends with support elements 21, 22, on the one hand, and base element 17, on the other.

Latching elements 24, 25 additionally each have a stiffening element 33, 34 by means of which the elasticity of latching elements 24, 25 is reduced in the region between latching lug 26, 27 and the upper cross section of the respective support element 21, 22. The respective stiffening element 33, 34 is formed in the shape of a trough as a protrusion that bulges outward from the respective latching element 24, 25. In this respect, stiffening elements 33, 34 are formed as bulges of latching elements 24, 25 in the section between latching lugs 26, 27 and the end associated with the support element.

In particular, stiffening elements 33, 34 extend up to the respective latching lug 26, 27 in such a way that they also partially form latching lug 26, 27 and thereby form a lateral projection that extends beyond actual latching lug 26, 27, as shown in particular in FIG. 6. FIG. 6 shows a sectional view through roof assembly 1 with fastening clamp 16 according to the example of FIG. 5, wherein the cutting plane lies in the center of fastening clamp 16 so that it passes centrally through latching elements 24, 25.

Because stiffening elements 33, 34 project laterally in the region of latching lugs 26, 27, they also form a retaining projection which engages further behind vehicle roof 2 or molded headliner 6 than the actual latching lug 26, 27 and, in particular, has a slope which is less steeply aligned with the plane of the molded headliner or vehicle roof 2, as a result of which it is more difficult to pull fastening clamp 16 out of roof opening 4. This ensures easy mounting and more difficult removal or increased security against unintentional loosening of fastening clamp 16.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A fastening clamp to fasten a molded headliner to a vehicle roof, the fastening clamp comprising:
a base element that is formed plate-shaped;
two support elements arranged opposite one another and extending away from the base element and at least substantially towards one another; and
a latching element projects from the support element and is arranged on each support element to latch the fastening clamp to the molded headliner or to the vehicle roof, the latching element being held in an elastically displaceable manner at an end of the respective support element on a side facing away from the base element and extends in a direction of the base element,
wherein the latching element has, spaced from the base element, a latching lug to engage behind an edge section of the molded headliner or the vehicle roof, and
wherein the respective latching lug projects from an outer side of the support element that faces away from the opposite support element.

2. The fastening clamp according to claim 1, wherein the base element has two guide rails arranged substantially parallel to one another, and each extending from one support element to the opposite support element, and projecting laterally from the support element for a rail guide.

3. The fastening clamp according to claim 1, wherein the support elements and the latching elements are each formed strip-shaped.

4. The fastening clamp according to claim 1, wherein the respective latching element has a free end spaced from the base element.

5. The fastening clamp according to claim 4, wherein the respective free end has a retaining element that extends parallel to the base section at least in the unloaded state of the fastening clamp.

6. The fastening clamp according to claim 1, wherein the support elements are formed integrally with the base element and have at least one bend in their course.

7. The fastening clamp according to claim 1, wherein the latching elements at one end are formed integrally with the respective support element.

8. The fastening clamp according to claim 1, wherein at the other end the latching elements are formed integrally with the base element.

9. The fastening clamp according to claim 1, wherein the fastening clamp is formed as a stamped-bent part.

10. The fastening clamp according to claim 1, wherein free ends of the support elements abut and/or are fastened to each other.

11. The fastening clamp according to claim 1, wherein one of the free ends of the support elements has a bending tab that is adapted to engage around the free end of the other support element.

12. A fastening system to fasten a molded headliner to a vehicle roof, a panoramic roof or a sliding roof, the fastening system comprising:
a bearing element that is adapted to be fastened to the molded headliner or the vehicle roof;
a receptacle to positively lock the fastening clamp according to claim 1, the fastening clamp being adapted to be held positively on the bearing element.

13. The fastening system according to claim 12, wherein the fastening clamp is arranged with its side edges displaceably in an insertion receptacle of the bearing element.

14. The fastening system according to claim 12, wherein the sliding direction of the fastening clamp on the bearing element is oriented transversely to a sliding direction of the latching elements on the vehicle roof or the molded headliner.

15. A roof assembly for a vehicle, in particular a motor vehicle, the roof assembly comprising:
a vehicle roof, a panoramic roof, or sliding roof, that has a roof frame in which a roof opening is formed;
a glass roof element that extends over the roof opening; and
a molded headliner fastened to an underside of the vehicle roof, which underside is associated with a vehicle interior, by a fastening system according to claim 12.

16. The fastening clamp according to claim 1, wherein the vehicle roof is a panoramic or sliding roof.
